(19) United States
(12) Patent Application Publication
(10) Pub. No.: US 2015/0108888 A1
(43) Pub. Date: Apr. 23, 2015

(54) RUBBISH COLLECTION TROLLEY

(71) Applicant: Massimo GALIMBERTI, (US)

(72) Inventor: Massimo Galimberti, London (GB)

(21) Appl. No.: 14/390,344

(22) PCT Filed: Apr. 3, 2013
(86) PCT No.: PCT/GB2013/000149

§ 371 Date: Oct. 2, 2014

(30) Foreign Application Priority Data
Apr. 5, 2012 (GB) 1206108.1
Jun. 21, 2012 (GB) 1211042.5

(51) Int. Cl. B65B 67/12; B65F 1/14; B65D 33/00; B65F 3/00

(52) U.S. Cl. CPC B65B 67/1216; B65F 3/005; B65F 1/1473; B65F 1/1646; B65D 33/004; B65B 2067/1294
USPC 312/270.3; 248/99; 312/237; 312/249.8; 312/326; 220/495.08; 383/105

(57) ABSTRACT

A trolley 2 for use in recyclable waste collection in an aircraft or other catering environment is conformal with a normal aircraft trolley. The trolley 2 comprises a horizontal tray 14 18 19 20 21 comprising a plurality of horizontal apertures, each aperture comprising a rubbish bag 19 20 held therein by its edges 22 between a tray base 14 and tray cover 18 that snap together. Before use the rubbish bags 19 20 are contained within the horizontal tray 14 18 19 20 and are freed to hang vertically within the trolley 2 when in use. The trolley 2 comprises a retractable lid which covers the tray assembly 14 18 19 20 21 when the trolley 2 is not in use. A liquid waste container 21 also fits into the tray and is independently removable for emptying without removing rubbish bags 19 20. The apertures and/or the rubbish bags 19 20 are colour coded according to the type of waste they are intended to receive and according to the colour coding employed in the country where recycling is intended to occur.

### FIELD OF THE INVENTION

The present invention relates to an apparatus for collecting waste items prior to collection and delivery for recycling. More particularly, the present invention relates to collection of waste items created as a consequence of transport catering. In greatest particularity, the present invention relates to an apparatus for use in aircraft, coaches and trains.

### BACKGROUND TO THE INVENTION

Passenger aircraft, and even cargo aircraft, even on short to medium haul flights, provide food and refreshment for the passengers and crew . The result of such activity is to create waste in many forms, including, but not limited to: food; plates: cutlery: crockery; paper waste of all kinds; bottles; and plastic items of all kinds. In current aircraft practice, all types of waste items are disposed of in the same bag or binliner resulting in all of the different types of item being mixed and thereby rendered unsuitable for recycling.

In the recent years recycling has become more popular throughout the world. In the United Kingdom, the government has encouraged councils to increase facilities to allow the recycling of waste. Current practice of airlines in the United Kingdom, is to have all waste and rubbish disposed of in the same one or more bags or binliner that is (are) then collected by a commercial contractors. The rubbish is later destroyed or placed in landfill sites with different types of waste all mixed up together. The present invention seeks to avoid such waste item mixing when disposing of waste in passenger transport situations.

Airlines in Spain and some northern European countries recycle waste from their flights. The present invention seeks to provide an apparatus that simplifies the organisation and operation of such recycling.

Catering on trains and in motorised coaches very closely resembles aircraft catering. The present invention also seeks to provide an apparatus suitable for providing recycling in trains, motorised coaches, and any other type of passenger transport vehicle such as, but not limited to, ships and hovercraft and even for static catering situations such as canteens and restaurants.

### SUMMARY OF THE INVENTION

The present invention consists in a rubbish collection trolley comprising:
a removable horizontal tray removeably insertable into the body of the trolley and comprising a plurality of horizontally adjacent apertures;
a plurality of rubbish bags each disposable one in each aperture;
and
an independently insertable and removable liquid waste container for receiving liquid waste.

The invention further provides that the rubbish bags can be held within the removable horizontal tray prior to use; and that the rubbish bags can be freed to hang vertically within the trolley when in use.

Invention also provides that the apertures can be colour coded according to the type of waste the associated rubbish bag is to contain and according to the colour code employed in the particular country where recycling is to occur.

The invention also provides that the rubbish bags can be colour coded according to the waste each type of bag is to contain and according to the colour code employed in the particular country where recycling is to occur.

The invention also provides that the liquid waste container can be removable from the tray in the trolley for emptying and replaceable into the tray in the trolley without requiring removal of rubbish bags.

The invention also provides that the trolley can comprise a retractable lid adapted to be movable to be retracted into the trolley when the trolley is in use and adapted to the movable to cover the horizontal tray when the trolley is not in use.

The invention also provides that the trolley can be used in at least one of: an aircraft; a ship; a hovercraft; a train; and a building, and when adapted for use in an aircraft, is conformal with a standard aircraft trolley, in which case the removable horizontal tray can comprise six apertures.

Invention also provides that the trolley can comprise a door, the door being closable to secure the horizontal tray within the trolley.

### BRIEF DESCRIPTION OF THE DRAWINGS

The invention is further explained, by way of example, by the following description, to be read in conjunction with the appended drawings, in which:

FIG. 1 is an angled overall view of an exemplary trolley suitable for use in the invention.

FIG. 2 is an angled view of the trolley of FIG. 1 with the door and lid open.

FIG. 3 is a partial view of the trolley of FIGS. 1 and 2 showing the handle of the retractable lid fully retracted

FIG. 4 is a view of detail A from FIG. 3 showing the close up of the support ledge for the lid.

FIG. 5 is a view of detail B from FIG. 3, showing a close-up of the lid rim and of the trolley lid retractable lid stowed inside the back panel.

FIG. 6 is a partially exploded view showing the tray base outside the trolley.

FIG. 7 is the view of FIG. 6 showing the the tray base inside the trolley

FIG. 8 shows an elevation the trolley in front view.

FIG. 9—shows an elevation of the trolley in side view with the retractable lid stored inside.

FIG. 10 shows detail D of FIG. 9 providing a close up of the rim for the lid and the rim for the tray.

FIG. 11 shows detail E of FIG. 9 providing a close up of the tray cover retracted inside the tray panel.

FIG. 12 shows a front view of the tray base and tray top.

FIG. 13—shows a top view of the tray with compartments.

FIG. 14 shows a cross sectional view of the tray base along the line FF when the tray base and tray top are locked together.

FIG. 15 shows an exploded view of the tray sections and components illustrating the dispositions of the tray base bearing folded rubbish bags, tray top and recycled plastic liquid disposer.

FIG. 16 shows the tray sections of FIG. 15 assembled together with the removable liquid waste container inserted and ready for use.

FIG. 17 shows a plan view of the assembled tray of FIG. 16.

FIG. 18 shows a cross sectional view of FIG. 17 taken along the line G-G

FIG. 19 shows detail capital H of FIG. 18 in close-up close cross sectional view.

FIG. 20 shows an angled view of the open trolley with full mounted tray outside ready to be positioned inside for use.

FIG. 21 shows the angled view of FIG. 21 with the tray positioned inside

FIG. 22 shows the view of FIG. 21 with the unfolded rubbish bags.

And

FIG. 23 shows a front elevation of the trolley of FIG. 22 illustrating dispositions of the unfolded bags and the liquid disposal in when assembled.

### DETAILED DESCRIPTION

The invention relates to a specifically designed trolley to collect and separate rubbish to allow easily recycling on aircraft. The trolley can also to be adapted for ships and trains or for use at other suitable venues such offices, private houses or any large gathering of people. The trolley allows the quick and easy separation of waste on an airplane to permit recycling at a hub station.

In the embodiment described below, the trolley is conformal with a standard aircraft trolley and consists in a standard aircraft trolley with specific modification to the top of the trolley. Specifically, the modifications allows for a tray to be inserted from the outside to the inside on the top of the trolley from the swing door via sliding motion.

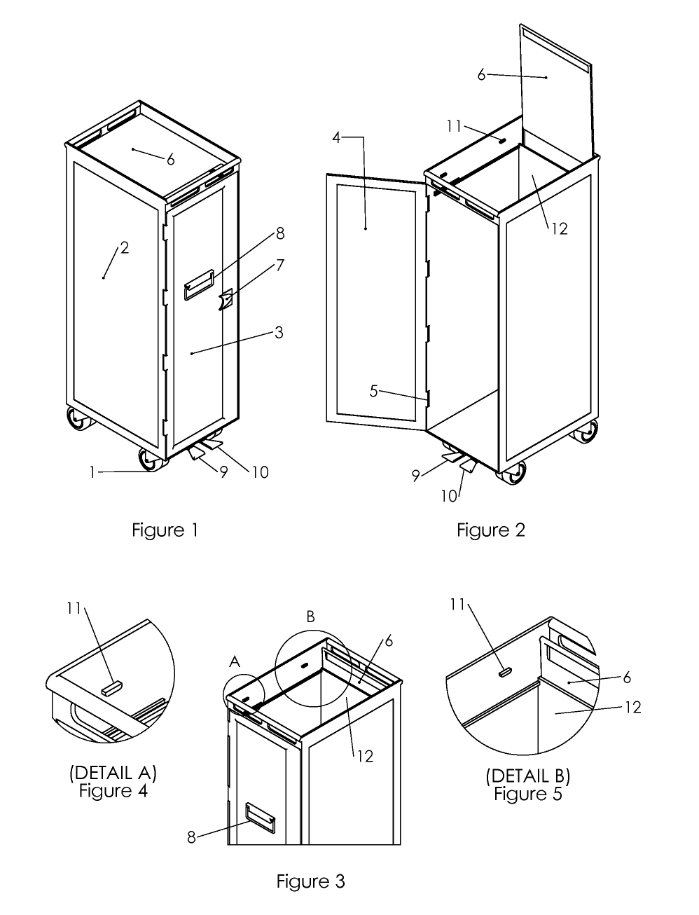

Attention is first drawn to FIG. 1, showing an angled overall view of an exemplary trolley suitable for use in the invention.

An exemplary trolley 2 comprises a retractable lid 6. The retractable lid 6 is shown in FIG. 1 in a closed position. The trolley 2 also comprises a front door 3 having a door handle 8 and a lock 7. A stop pedal 9 can be used to brake rubber wheels 1 and a release pedal 10 can be used to release the rubber wheels 1.

In the example given, for recycling waste in aircraft, the trolley illustrated in FIG. 1 is a standard aircraft trolley of a rectangular shape with resin panels 4 with four rubber wheels 1 with two wheels 1 at the front and two wheels 1 at the back. The twin pedal 9 10 brake system at the front of the trolley can be pushed up and down to stop and release the brakes.

Attention is next drawn to FIG. 2, showing an angled view of the trolley 2 of FIG. 1 with the door 3 and lid 6 open. In FIG. 2 the retractable lid 6 is shown in an opened position, with an inside door panel 4 provided on the inside of the door 3. The door 3 is supported on the trolley to by door hinges 5. Rim support 11 is provided for the retractable lid 6 by a plurality of spaced support ledges 11 upon which the retractable lid 6 rests when closed. A panel area 12 is provided within the back panel of the trolley 2 that accepts and retains the retractable lid 6 when the retractable lid is in the fully retracted position.

Attention is next drawn to FIG. 3, a partial view of the trolley of FIGS. 1 and 2 showing the handle of the retractable lid 6 fully retracted. Attention is also drawn to FIG. 4, a view of detail A from FIG. 3 showing a close up of the support edge for the retractable lid 6 as defined by a plurality of horizontally spaced support ledges 11 where on the retractable lid 6 rests when closed. Attention is further drawn to FIG. 5, a view of detail B from FIG. 3, showing a close-up of the retractable lid 6 support ledge 11 rim and of the retractable lid 6 stowed inside the back panel 12 of the trolley 2.

Unlike pre-existing standard aircraft trolleys, the rubbish collector trolley 2 of the present invention has a full length retractable lid 6 on its top adapted to sit on top of a rim consisting of a plurality of horizontally spaced support ledges 11. When the retractable lid six is lifted 90 degrees it can be retracted into the inside of the back of the trolley 2 to be stored inside the panel 12 away from rubbish bags 19 20 (see FIGS. 15, 16, 22 and 23).

In the retracted position, only a handle at its top edge is exposed, as shown in FIG. 3. This leaves the top of the trolley 2 completely open allowing maximum use of the area unlike pre- existing trolleys that have only a one small central hole.

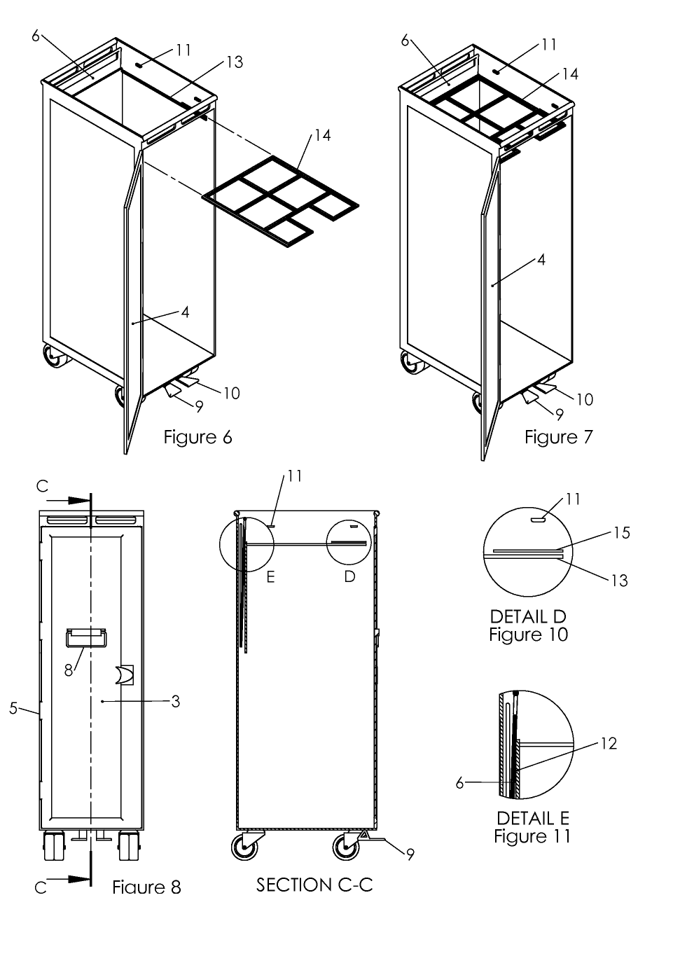

Attention is next drawn to FIG. 6, a partially exploded view showing a tray base outside the trolley. In FIG. 6, a tray base 14 is shown outside the trolley 2 having been removed from or yet to be inserted into a tray slide 13. The tray base 14 comprises six compartments (in this example) for rubbish. The tray base also comprises a rim (not shown) adapted to fit into the tray slide 13 to enable it to be inserted into and withdrawn from the trolley 2.

Attention is next drawn to FIG. 7, a view of FIG. 6 showing the tray base 14 inside the trolley 2. The tray base 14 is slid into the tray slide 13 to but a of the inside the trolley 2. The inserted tray base 14, held in the tray slide 13, rests below the support ledge 11 rim.

Attention is next drawn to FIG. 8 showing an elevation the trolley in front view. When the retractable lid 6 is fully closed as shown, the door 3 is also closed as shown and the tray base 14 is inserted, the tray base 14 is concealed from view and sealed from the immediate environment.

FIG. 9 shows an elevation of the trolley 2 in cross sectional view cut by the plane CC of FIG. 8 with the retractable lid 6 stored inside. Attention is also drawn to FIG. 10 that shows detail D of FIG. 9 providing a close-up of the spaced support ledge 11 rim for retractable lid 6 and the tray slide 13 for tray base 40. Attention is further also drawn to FIG. 11 shows detail E of FIG. 9 providing a close up of the retractable lid 6 retracted inside the panel area 12.

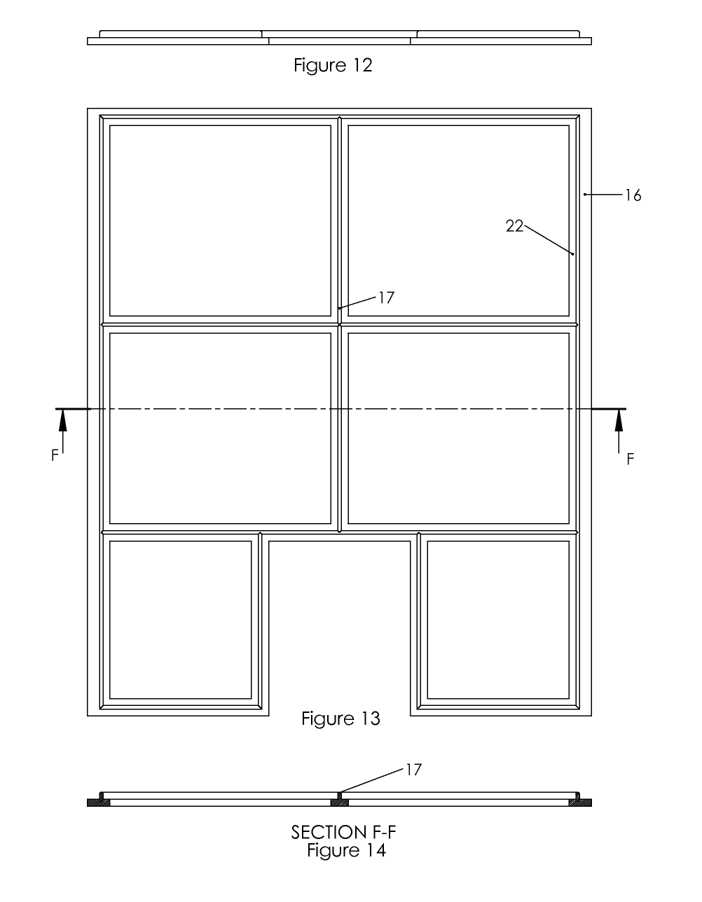

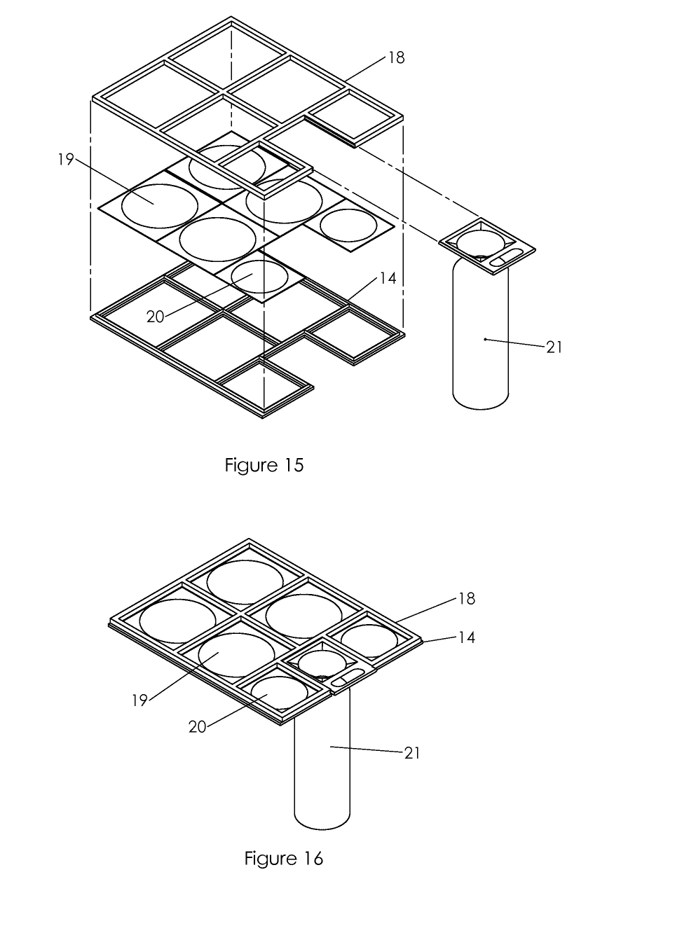

Attention is next drawn to FIG. 12, showing a front view of the tray base 14 and a tray cover 18. Attention is also drawn to FIG. 13 showing a view from above of the tray 14 with compartments. Attention is further drawn to FIG. 14 shows a sectional view of tray base 14 and tray cover 18 (see FIG. 15 and FIG. 16) locked together.

The tray comprises two parts, a tray base 14 and tray cover 18. Rubbish bags 19 20 (shown in FIG. 15) are held between the tray cover 18 and tray base 14. The tray base 14 and tray cover 18 can be locked together by an interlocking mechanism with the rubbish bags 19 20 secured there between, as shown in FIG. 16. Each rubbish bag 19 20 (shown in FIG. 15) can be folded over edges 22 of a respective aperture of the tray base 14 and held in place and secured by the tray cover 18 (see FIGS. 15 and 16) so when a rubbish bag 19 20 starts to fill, it is restrained from falling inside the trolley 2. In use, waste items are collected into individual rubbish bags 19 20, each rubbish bag 19 20 being designated to contain a selected type of waste content.

Attention is next drawn to FIG. 15, showing an exploded view of the tray sections and components illustrating the dispositions of the tray base 14 bearing folded rubbish bags 19 20, tray cover 18 and recycled plastic liquid waste container 21. Attention is also drawn to FIG. 16 showing the tray sections of FIG. 15 assembled together with the removable liquid waste container 21 inserted and ready for use. FIG. 16 shows the liquid waste container 21 inserted in the tray base 14 ready to receive liquid waste. FIG. 15 shows how the liquid waste container 21 can be removed from the rack independently of other bags 19 20.

The tray assembly 14 18 19 20 21 is preferably prepared and supplied with bin liners/rubbish bags 19 20 already in situ to save cabin crew rubbish bag 19 20 installation time.

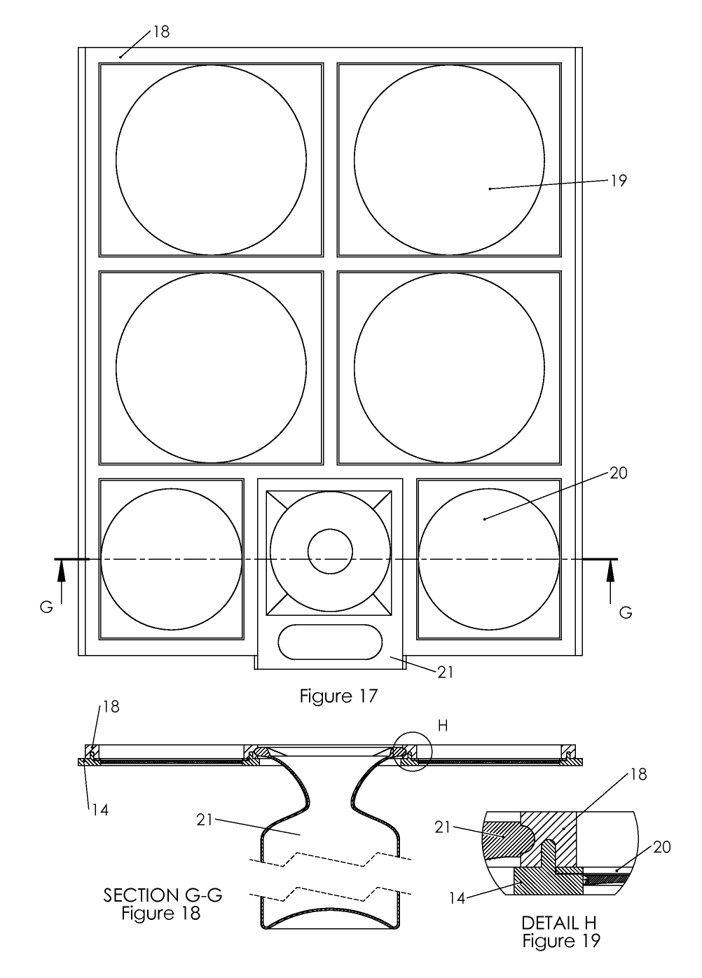

Attention is next drawn to FIG. 17 showing a plan view of the assembled tray of FIG. 16. Attention is also drawn to FIG. 18 showing a cross sectional view of the assembled tray along the line GG of FIG. 17. Attention is further drawn to FIG. 19, showing a close-up detailed view of highlight H of FIG. 17. In FIG. 19, the tray base 14 presents a tongue and groove joining assembly with the tray cover 18, the liquid waste container 21 is accepted into grooves in the tray cover 18.

Attention is next drawn to FIG. 20, illustrating how a tray assembly can be inserted into the trolley 2. The rubbish bags 19 20 are shown in FIG. 20 still in their “not let down” condition. The liquid waste container 21 is shown inserted into its position, although, as will be understood, it can be inserted later. The door 3 4 is open to accept insertion of the tray assembly 14 18 19 20 21.

Moving to FIG. 21, showing the next stage on from FIG. 20 in assembly of the tray assembly 14 18 19 20 21 into the trolley 2, the tray base 14 is inserted to lie within the tray slide 13 (as shown in FIGS. 6 and 10).

Moving to FIG. 22, showing a further stage in assembly of the tray assembly 14 18 19 20 21 within the trolley 2, the rubbish bags 19 20 are then let down to lie within the trolley 2. The ends of the rubbish bags 19 20 are clear of the inside of the base of the trolley 2.

Finally, attention is drawn to FIG. 23 showing an elevation of the front of the trolley 2 with the door 3 4 open, illustrating the dispositions of the rubbish bags 19 20.

The tray assembly 14 18 19 20 21 is held by the rim 13 which supports the tray base 14. The tray assembly 14 18 19 20 21 is thereby suspended to allow the rubbish bags 19 20 to unfold inside the trolley 2 for the collection of different types of rubbish.

The door 3 4 can then be closed. The retractable lid 6 can also be closed until the trolley 2 is ready to receive waste. The liquid waste container 21 is smaller in vertical extent than the let-down rubbish bags 19 20 as the weight of liquid waste is very great even in small volumes, making removal and emptying of the liquid waste container 21 a difficult task if the liquid waste container 21 is made too large. Further, the liquid waste container is likely to require emptying at frequent intervals. In use, the liquid waste container 21 can be independently removed from the trolley 2 by opening the door 3 4. Liquid waste can them be disposed of in any normal way that other liquid waste would be disposed of in that form of transport. Generally speaking, liquid waste can be jettisoned and/or emptied upon arrival. When the door 3 4 is closed the tray assembly 14 18 19 20 21 is fixed into place and unable to move relative to the trolley 2.

The liquid waste container 21 can be used, for example, to receive unwanted ice and hot/cold drinks left by passengers which can be emptied therein. The liquid waste container 21 is also provided with a handle enabling the liquid waste container 21 to be removed and emptied then put back into position in the trolley 2.

The door 3 4 must be shut from the handle 8 and locked using the lock 7 to fix the tray assembly 14 18 19 20 21 position. Recycling of any material/rubbish will only be from the top of the trolley 2 with the retractable lid 6 open.

In the example shown, the door 3 is fitted to one side of the trolley 2 by four hinges 5. The invention also allows for any other means of attachment for the door 3.

In the example shown is specifically for use in aircraft, and provides a maximum of six compartments. These are coloured coded according to the product waste and the country where the trolley 2 will be used. It is also to be appreciated that the rubbish bags 19 20 can also be colour-coded according to the custom of the recycler. It is to be appreciated that a number other than six rubbish bags 19 20 can be employed with the invention. It is preferred that the rubbish bags 19 20 are transparent to conform with airline requirements. Transparent rubbish bags 19 20 are also a requirement in many other situations.

In use, cabin crew will fill the rubbish bags 19 20 during a flight. At the end of the flight the full bags 19 20 be tied and then taken away by the cleaning company that operates on the aircraft (these cleaning contractors already remove waste from the aircraft).

In the event of one or more of the rubbish bags 19 20 becoming fall, the aircrew can remove an existing full tray assembly (minus the liquid waste container 21) and replace it with a fresh tray assembly 14 18 19 20 with the rubbish bags 19 20 not yet let down.

The present invention provides an environmental, material saving and energy saving advantage. Recycling of materials reduces energy requirements in provision of new materials. Reduction in dumping or burning provides a clear environmental improvement. Instead of disposing of all waste and rubbish in one rubbish bag 19 20 or binliner, a system is provided for use on board and aircraft (or ship, a train etc) to divide the rubbish according to its type. This precaution avoids a problem found when all rubbish its mixed together that some or all of the waste cannot be recycled because contamination.

Use of the rubbish disposal trolley 2 allows for easy and speedy separation of different types of rubbish accordingly to their type e.g. plastic, paper, cans, metallic items, glass or food, thereby allowing airlines and other passenger transport vehicles, as well as all manner of catering establishments to recycle items expeditiously.

The trolley 2 is, for preference, made from resin and recycled aluminium in order to remain lightweight and also to be environmentally friendly. The tray sections 14 18, together with the hard plastic liquid waste container 21 are preferably made from recycled plastic for the same reasons. It is to be understood, that within the invention as claimed, other materials may be used. In non-aircraft use, heavier materials are possible.

For preference, rubbish bags 19 20 are made from recycled biodegradable polyethylene.

Those skilled in the art will be aware of modifications and variations that can be applied to the invention as described without deviating from the invention as claimed.

The invention is further defined by the following appended claims.

1. A rubbish collection trolley comprising:
a removable horizontal tray removeably insertable into the body of the trolley and comprising a plurality of horizontally adjacent apertures;
a plurality of rubbish bags each disposable one in each aperture;
and
an independently insertable and removable liquid waste container for receiving liquid waste.

2. The trolley of claim 1 wherein:
rubbish bags are held within the removable horizontal tray prior to use; and wherein
rubbish bags are freed to hang vertically within the trolley when in use.

3. The trolley of claim 1 or claim 2 wherein the apertures are colour coded according to the type of waste the associated rubbish bag is to contain and according to the colour code employed in the particular country where recycling is to occur.

4. The trolley of any of the preceding claims wherein the rubbish bags are colour coded according to the waste each type of bag is to contain and according to the colour code employed in the particular country where recycling is to occur.

5. The trolley of any of the preceding claims wherein the liquid waste container is removable from the tray in the trolley for emptying and replaceable into the tray in the trolley without requiring removal of rubbish bags.

6. The trolley of any of the preceding claims comprising a retractable lid adapted to be movable to be retracted into the trolley when the trolley is in use and adapted to the movable to cover the horizontal tray when the trolley is not in use.

7. The trolley of any of the preceding claims adapted for use in at least one of: an aircraft; a ship; a hovercraft; a train; and a building.

8. The trolley of claim 7, where, when adapted for use in an aircraft, is conformal with a standard aircraft trolley.

9. The trolley of claim 8 where the removable horizontal tray comprises six apertures.

10. The trolley of any of the preceding claims comprising a door, the door being closable to secure the horizontal tray within the trolley.

11. A trolley, substantially as described with reference to the appended drawings.
